(19) United States
(12) Patent Application Publication
(10) Pub. No.: US 2025/0083032 A1
(43) Pub. Date: Mar. 13, 2025

(54) PUZZLE TABLE

(71) Applicant: Shenzhen Shi Hu Lian Heng Tong Trading Co., Ltd., Shenzhen (CN)

(72) Inventors: Meng Zhang, Shenzhen (CN); Xiaoling Che, Dangyang (CN)

(21) Appl. No.: 18/959,712

(22) Filed: Nov. 26, 2024

Related U.S. Application Data
(63) Continuation-in-part of application No. 18/783,453, filed on Jul. 25, 2024.
Application No. 18/783,453 is a continuation-in-part of application No. 17/829,359, filed on Jun. 1, 2022, now Pat. No. 12,104,744.
(63) Continuation-in-part of application No. 18/748,158, filed on Jun. 20, 2024.
(63) Continuation-in-part of application No. 18/736,862, filed on Jun. 7, 2024.
(63) Continuation-in-part of application No. 18/737,905, filed on Jun. 7, 2024.
(63) Continuation-in-part of application No. 18/732,602, filed on Jun. 3, 2024, now Pat. No. 12,186,676.

(30) Foreign Application Priority Data
Apr. 18, 2024 (CN) 202430220715.2
May 23, 2024 (CN) 202430309522.4
Jun. 19, 2024 (CN) 202430377406.6
Nov. 11, 2024 (CN) 202422744898.5

(51) Int. Cl. A63F 9/10

(52) U.S. Cl. CPC A63F 9/1044

(57) ABSTRACT

The present disclosure provides a puzzle table. The puzzle table includes at least two puzzle plates and at least one connecting assembly. Each of the at least one connecting assembly is configured to connect two adjacent puzzle plates of the at least two puzzle plates. The each of the at least one connecting assembly includes a first connecting element and a second connecting element. The first connecting element is mounted on one of the at least two puzzle plates, and the second connecting element is mounted on an adjacent other of the at least two puzzle plates. The first connecting element and the second connecting element are capable of being inserted into each other, such that the at least two puzzle plates can be spliced with each other in parallel to form an integrated body.

### CROSS-REFERENCE TO RELATED APPLICATION

This application is a continuation-in-part of: the U.S. patent application Ser. No. 18/783,453, filed on Jul. 25, 2024; the U.S. patent application Ser. No. 17/829,359, filed on Jun. 1, 2022; the U.S. patent application Ser. No. 18/748,158, filed on Jun. 20, 2024; the U.S. patent application Ser. No. 18/736,862, filed on Jun. 7, 2024; the U.S. patent application Ser. No. 18/737,905, filed on Jun. 7, 2024; and the U.S. patent application Ser. No. 18/732,602, filed on Jun. 3, 2024. The present application claims the priority of: Chinese Patent Application No. 202422744898.5, filed on Nov. 11, 2024; Chinese Patent Application No. 202430220715.2, filed on Apr. 18, 2024; Chinese Patent Application No. 202430377406.6, filed on Jun. 19, 2024; and Chinese Patent Application No. 202430309522.4, filed on May 23, 2024. Contents of which are hereby incorporated by reference in their entireties.

### FIELD

The present disclosure relates to the field of puzzle tools, and in particular to a puzzle table.

### BACKGROUND

Existing puzzle tables are generally plate-shaped and have a relatively large area, resulting in high costs for packaging and transporting and inconvenience in storage.

### SUMMARY

The present disclosure provides a puzzle table. The puzzle table includes at least two puzzle plates and at least one connecting assembly. Each of the at least one connecting assembly is configured to connect two adjacent puzzle plates of the at least two puzzle plates. The each of the at least one connecting assembly includes a first connecting element and a second connecting element. The first connecting element is mounted on one of the at least two puzzle plates, and the second connecting element is mounted on an adjacent other of the at least two puzzle plates. The first connecting element and the second connecting element are capable of being inserted into each other. When the first connecting element and the second connecting element are inserted into each other, the at least two puzzle plates are spliced with each other, and upper faces of the at least two puzzle plates are substantially flush with each other.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a structural view of a plurality of puzzle plates spliced with each other according to an embodiment of the present disclosure.

FIG. 2 is an enlarged view of a portion A in FIG. 1.

FIG. 3 is a structural view of a bottom portion of a puzzle table according to an embodiment of the present disclosure.

FIG. 4 is an enlarged view of a portion B in FIG. 3.

FIG. 5 is a schematic view of a connecting assembly in FIG. 4 after being disassembled.

FIG. 6 is a first schematic view of the plurality of puzzle plates separated from each other according to an embodiment of the present disclosure.

FIG. 7 is a second schematic view of the plurality of puzzle plates separated from each other according to an embodiment of the present disclosure.

FIG. 8 is a structural view of a first plate according to an embodiment of the present disclosure.

FIG. 9 is a structural view of a second plate according to an embodiment of the present disclosure.

FIG. 10 is a structural view of a third plate according to an embodiment of the present disclosure.

FIG. 11 is a schematic connection view of the first plate, the second plate, and the third plate according to an embodiment of the present disclosure.

FIG. 12 is a vertical cross-section view of a connecting position between a first connecting element and a second connecting element according to an embodiment of the present disclosure.

FIG. 13 is a schematic distribution view of the first and second connecting elements connected to the plurality of puzzle plates according to an embodiment of the present disclosure.

FIG. 14 is a schematic distribution view of the first and second connecting elements connected to the plurality of puzzle plates according to another embodiment of the present disclosure.

FIG. 15 is a schematic view of bottom plates connected to the bottom portion of the plurality of puzzle plates according to an embodiment of the present disclosure.

FIG. 16 is a schematic connection view between the bottom plates and first connecting portions by screws according to an embodiment of the present disclosure.

FIG. 17 is a schematic view of an annular structure connected to the bottom portion of the plurality of puzzle plates according to another embodiment of the present disclosure.

FIG. 18 is a schematic view of both a plate-like structure and the annular structure connected to the bottom portion of the plurality of puzzle plates according to an embodiment of the present disclosure.

FIG. 19 is a schematic connection view between a drawer element and a corresponding puzzle plate according to an embodiment of the present disclosure.

FIG. 20 is a schematic view of defining two elastic notches respectively at two sides of a clamping boss according to an embodiment of the present disclosure.

### REFERENCE NUMERALS IN THE DRAWINGS

puzzle plate 1,

upper face 10 of the puzzle plate 1,

top plate 11,

side plate 12,

clamping gap 110,

first plate 101,

second plate 102,

third plate 103,

anti-disengagement boss 1031,

anti-disengagement groove 1032,

drawing groove 120,

clamping boss 121,

elastic notch 122,

elastic post 123,

supporting bar 110;

connecting assembly 2,

first connecting element 21,

second connecting element 22,

first connecting portion 211,

inserting boss 212,

baffle 213,

second connecting portion 221,

inserting groove 222,

clamping plate 223,

upper face 2110 of the first connecting portion 211,

side 2210 of the second connecting portion 221 away from the puzzle plate 1 to which the second connecting portion 221 is connected,

edge plate 2211,

wall plate 2212,

first abutting face 2121,

second abutting face 2231;

base 3,

bottom plate 31,

plate-like structure 301,

annular structure 302;

drawer element 4,

clamping groove 41;

screw 5.

### DETAILED DESCRIPTION

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

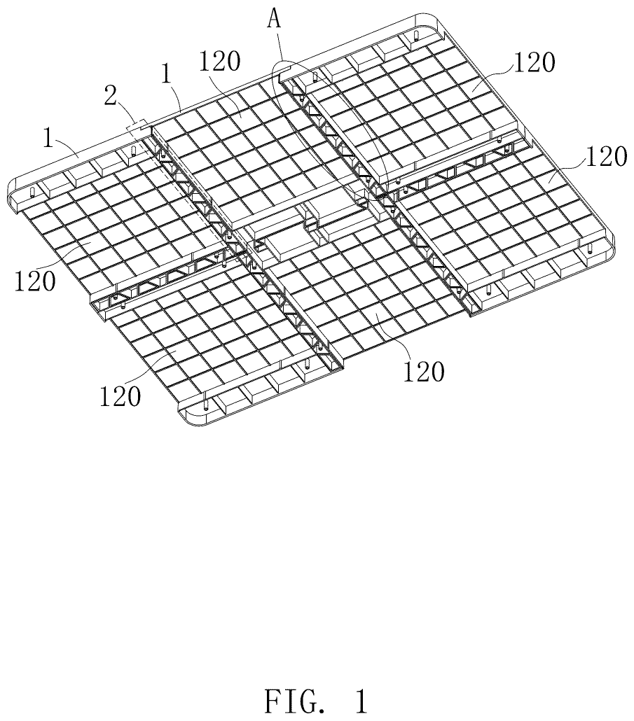

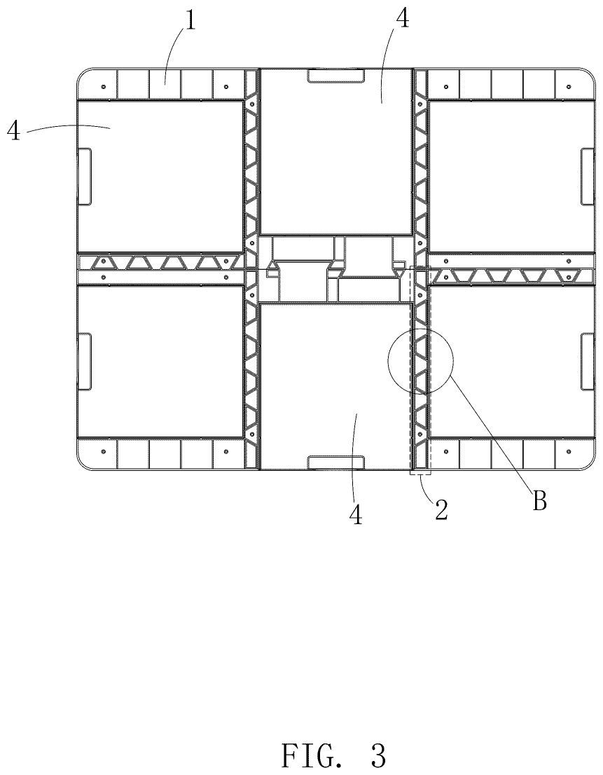

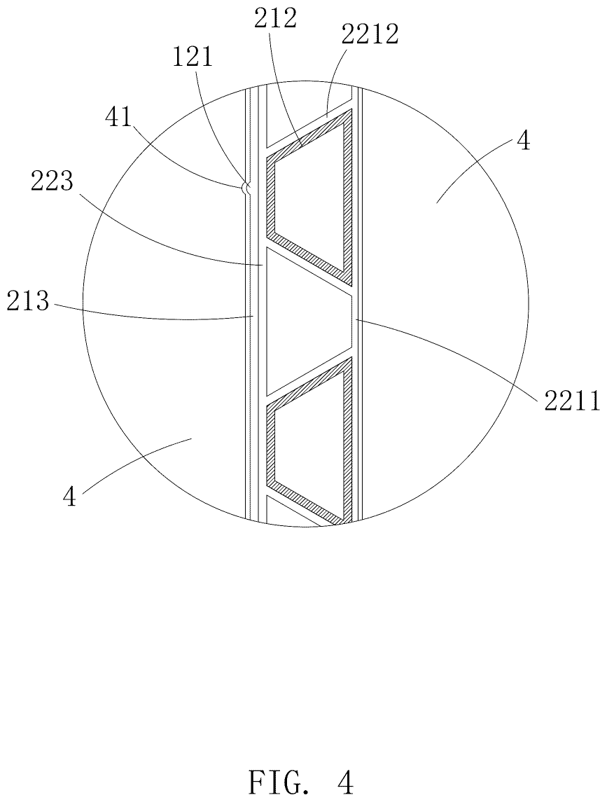

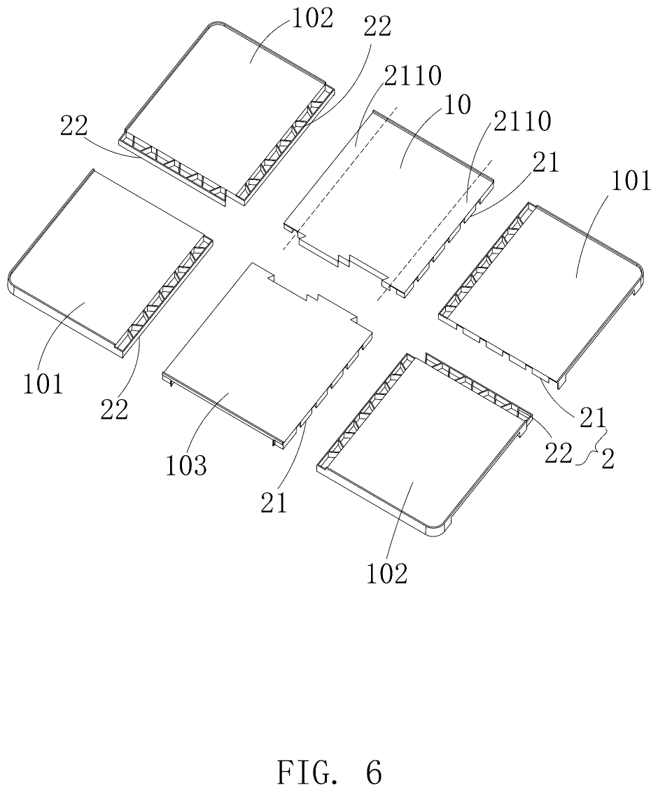

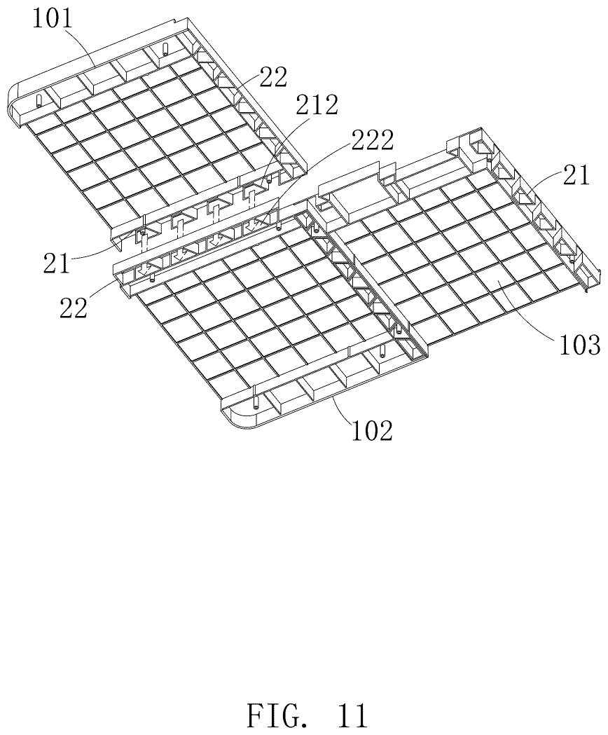

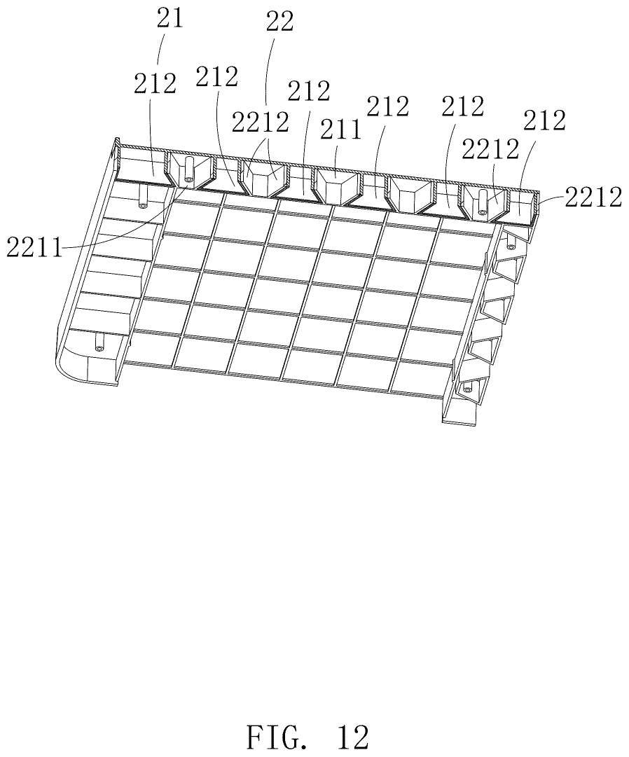

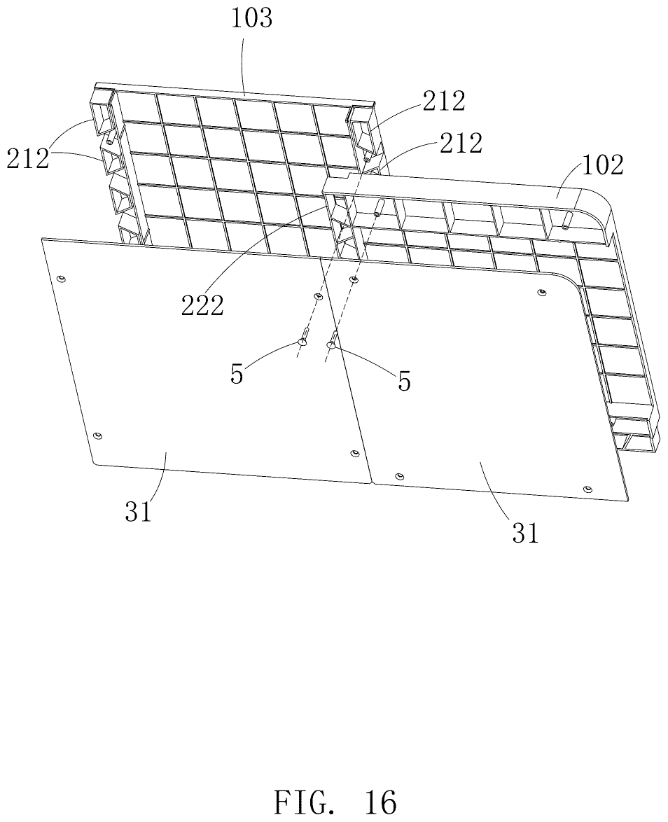

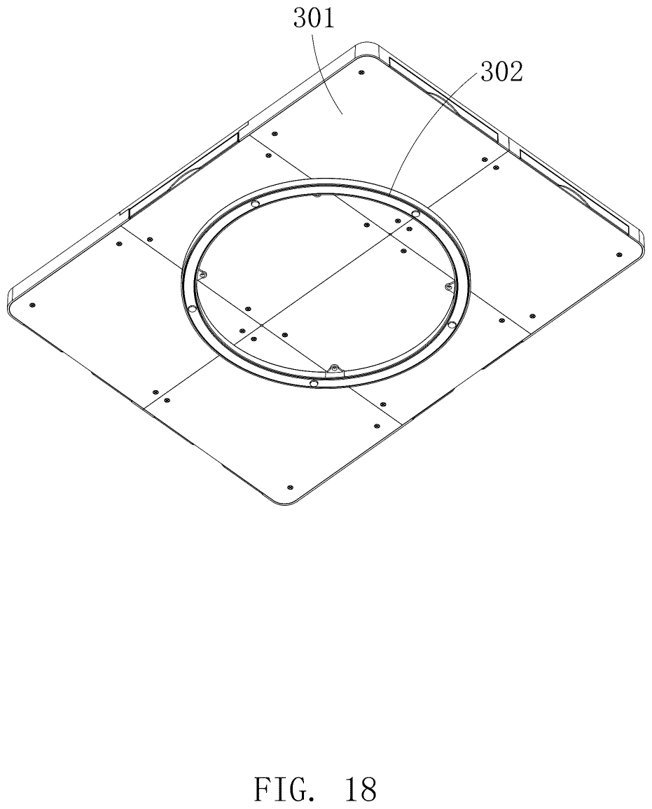

Referring to FIGS. 1 to 19, the present disclosure provides a puzzle table. The puzzle table includes at least two puzzle plates 1 and at least one connecting assembly 2. Each of the at least one connecting assembly 2 is configured to connect two adjacent puzzle plates 1 of the at least two puzzle plates 1, enabling the puzzle table to realize functions of splicing and disassembly.

Specifically, the each of the at least one connecting assembly 2 includes a first connecting element 21 and a second connecting element 22. The first connecting element 21 is mounted on one of the at least two puzzle plates 1, and the second connecting element 22 is mounted on an adjacent other of the at least two puzzle plates 1. The first connecting element 21 and the second connecting element 22 are capable of being inserted into each other. When the first connecting element 21 and the second connecting element 22 are inserted into each other, the at least two puzzle plates 1 are spliced with each other in parallel to form an integrated body, and upper surfaces 10 of the at least two puzzle plates 1 are substantially flush with each other.

Specifically, any two adjacent puzzle plates 1 are spliced and fixed to each other by means of a corresponding connecting assembly 2. Therefore, when transportation and storage are required, an insertion relationship between the first connecting element 21 and the second connecting element 22 can be released, thus the at least two puzzle plates 1 can be stacked to reduce an occupied space.

Furthermore, in order to prevent the two adjacent puzzle plates 1 from being easily separated from each other after the first connecting element 21 and the second connecting element 22 are inserted into each other, in the present embodiment, the first connecting element 21 and the second connecting element 22 are inserted into one another in an interference fit. In other words, when the user splices the two adjacent puzzle plates 1, a large external force needs to be applied. In this embodiment, the two adjacent puzzle plates 1 are fixed by a large frictional force between the first connecting element 21 and the second connecting element 22.

In order to facilitate the user to apply the external force, in this embodiment, an inserting direction between the first connecting element 21 and the second connecting element 22 is perpendicular to the upper faces 10 of the at least two puzzle plates 1. In addition, each of the first connecting element 21 and the second connecting element 22 is connected to an edge of a corresponding puzzle plate 1.

Regarding an insertion between the first connecting element 21 and the second connecting element 22, in this embodiment, specifically, the first connecting element 21 includes a first connecting portion 211, and an inserting boss 212 is arranged on the first connecting portion 211. The second connecting element 22 includes a second connecting portion 221, and the second connecting portion 221 defines an inserting groove 222. Each of the first connecting portion 211 and the second connecting portion 221 is connected to a corresponding puzzle plate 1. In other words, one of the two adjacent puzzle plates 1 is connected with the first connecting portion 211, and the other of the two adjacent puzzle plates 1 is connected with the second connecting portion 221. After the inserting boss 212 is inserted into the inserting groove 222 in the interference fit, the two adjacent puzzle plates 1 can be spliced with each other.

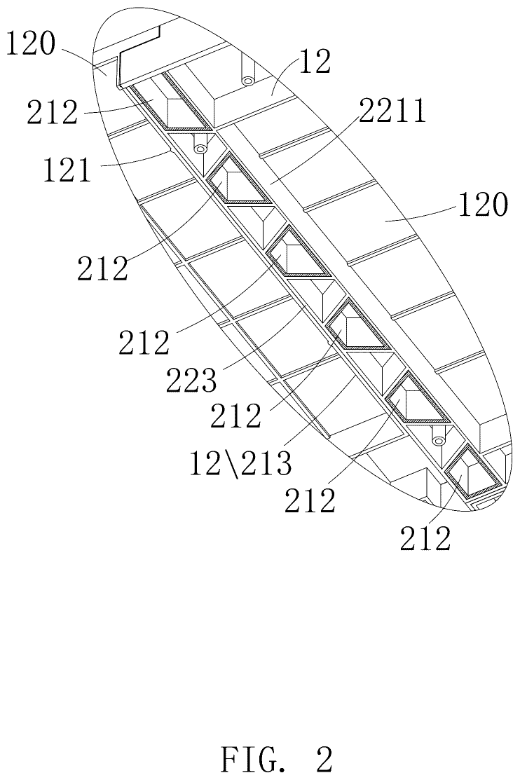

In order to enhance connection strength between the first connecting element 21 and the second connecting element 22, i.e., to increase the frictional force between the first connecting element 21 and the second connecting element 22, as shown in FIGS. 2 to 10, in this embodiment, the first connecting element 21 further includes a baffle 213 arranged on the first connecting portion 21. The baffle 213 is connected to an edge of a bottom face of a corresponding puzzle plate 1. The first connecting portion 211 is arranged on a side of the baffle 213 away from the corresponding puzzle plate 1. A clamping gap 110 is defined between the inserting boss 212 and the baffle 213. The second connecting element 22 further includes a clamping plate 223. The clamping plate 223 is connected to a side 2210 of the second connecting portion 221 away from a corresponding puzzle plate 1 to which the second connecting portion 221 is connected. When the inserting boss 212 is inserted into the inserting groove 222, the clamping plate 223 is disposed in the clamping gap 110. Since the inserting boss 212 is inserted into the inserting groove 222 in the interference fit, the inserting boss 212 may exert pressure on a side wall of the second connecting portion 221 corresponding to the inserting groove 222, causing the side wall of the second connecting portion 221 to have an external extension trend, driving the clamping plate 223 to deform towards the baffle 213. In this way, the clamping plate 223 tightly abuts against the baffle 213, thereby providing a greater frictional force to stabilize the connection between the first connecting element 21 and the second connecting element 22.

In addition, in another embodiment, the inserting boss 212 and the inserting groove 222 may be mated with each other in a clearance fit, while the clamping plate 223 is inserted into the clamping gap 110 in the interference fit. The difference between this another embodiment and the previous embodiments lies only in magnitude of the frictional force between the first connecting element 21 and the second connecting element 22.

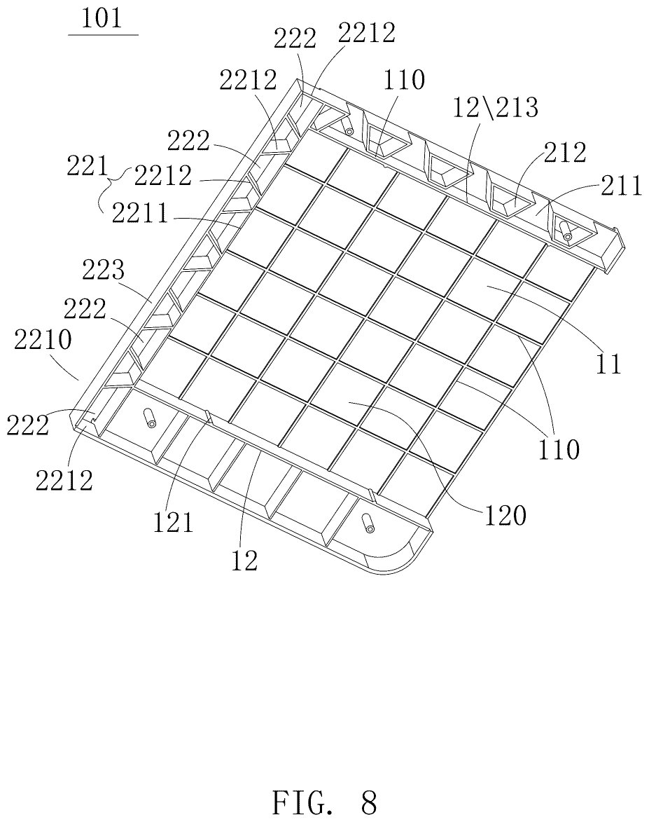

Furthermore, regarding a shape and structure of the second connecting portion 221, in this embodiment, the second connecting portion 221 includes an edge plate 2211 and at least two wall plates 2212. The edge plate 2211 is connected to an edge of a corresponding puzzle plate 1. The clamping plate 223 is connected to the edge plate 2211 through the at least two wall plates 2212. The edge plate 2211, the clamping plate 223, and the at least two wall plates 2212 jointly enclose to form the inserting groove 222. Each first connecting element 21 is arranged with a plurality of inserting bosses 212, and correspondingly, each second connecting element 22 may open a plurality of inserting grooves 222. All of the plurality of inserting grooves 222 share a same edge plate 2211 and a same clamping plate 223. Each two of the at least two wall plates 2212 may jointly form one inserting groove 222. A number of the wall plates 2212 is positively correlated with a number of the inserting grooves 222. In an example, the second connecting element 22 connected to the puzzle plate 1 as shown in FIG. 8 includes twelve wall plates 2212 which form six inserting grooves 222 with a same shape or different shapes.

A shape of the inserting groove 222 may be triangular, circular, arc-shaped pentagonal, trapezoidal, or other irregular shapes, as long as an outer shape of the inserting boss 212 matches the shape of the inserting groove 222. Additionally, a contact between the inserting groove 222 and the inserting boss 212 is a surface contact.

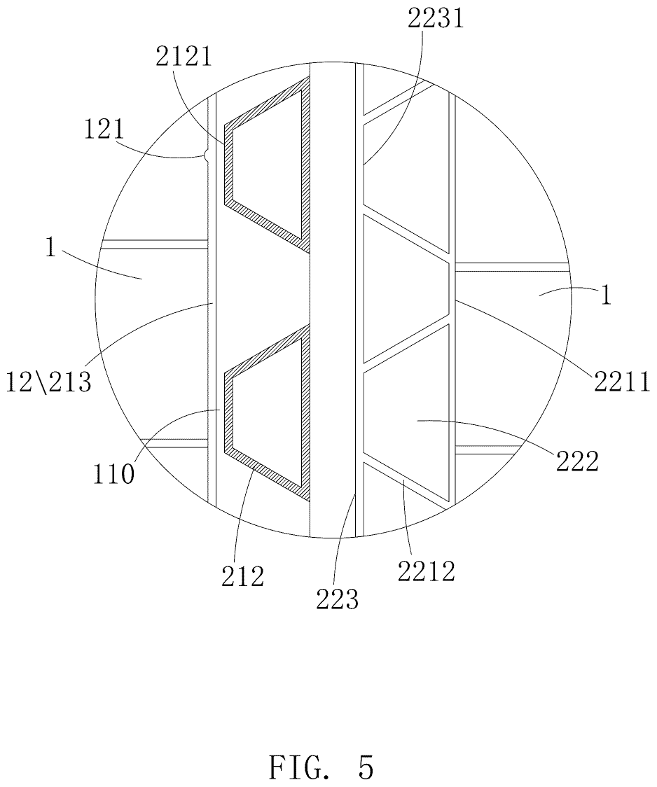

Correspondingly, when the inserting boss 212 is inserted into the inserting groove 222, the inserting boss 212 may directly squeeze the clamping plate 223. Furthermore, in order to improve squeezing effect of the inserting boss 212 on the clamping plate 223, in this embodiment, as illustrated in FIG. 5, the inserting boss 212 has a first abutting face 2121, the first abutting face 2121 is a flat face or a curved face, and the clamping plate 223 has a second abutting face 2231 corresponding to the inserting groove 222. A shape of the second abutting face 2231 matches that of the first abutting face 2121. The first abutting face 2121 abuts against the second abutting face 2231. The first abutting face 2121 is used to increase a contact area between the inserting boss 212 and the clamping plate 223, so that the clamping plate 223 can deform in a larger area. Particularly, the inserting groove 222 is in a shape of a quadrangle and at least some of the inserting grooves 222 are in a shape of a trapezoid. Correspondingly, at least some of the inserting bosses 212 are in the shape of a trapezoid. One of wall faces of the some of the inserting boss 212 is the first abutting face 2121. In addition, the other three wall faces of the some of the inserting bosses 212 are squeezed by two wall plates 2212 and the edge plate 2211, thus expanding a contact area between the inserting boss 212 and the second connecting portion 221.

Specifically, the first connecting portion 211 is plate-like. An upper face 2110 of the first connecting portion 211 is substantially flush with an upper face 10 of a corresponding puzzle plate 1. The inserting boss 212 is located at a side of the first connecting portion 211 away from the upper face 2110. The inserting groove 222 vertically penetrates the second connecting portion 221. The inserting boss 212 can be inserted into the inserting groove 222 from a top to a bottom of the inserting groove 222, so that the first connecting portion 211 overlaps the second connecting portion 221, playing a role in aesthetics, enabling a spliced surface of the puzzle table complete, and reducing gaps of the spliced surface.

Further, the inserting boss 212 is hollow, which can save raw material cost. In addition, since a wall of the inserting boss 212 is thinner, it enables the inserting boss 212 easier to deform. When the inserting boss 212 squeezes the clamping plate 223, deformation is evenly distributed on the inserting boss 212 and the clamping plate 223, preventing the clamping plate 223 from being over-deformed and broken.

It should be noted that each of the first connecting portion 211 and the second connecting portion 221 is integrally formed on and connected with a corresponding puzzle plate 1 as a one-piece structure, thereby sharing a same set of molds with the corresponding puzzle plate 1.

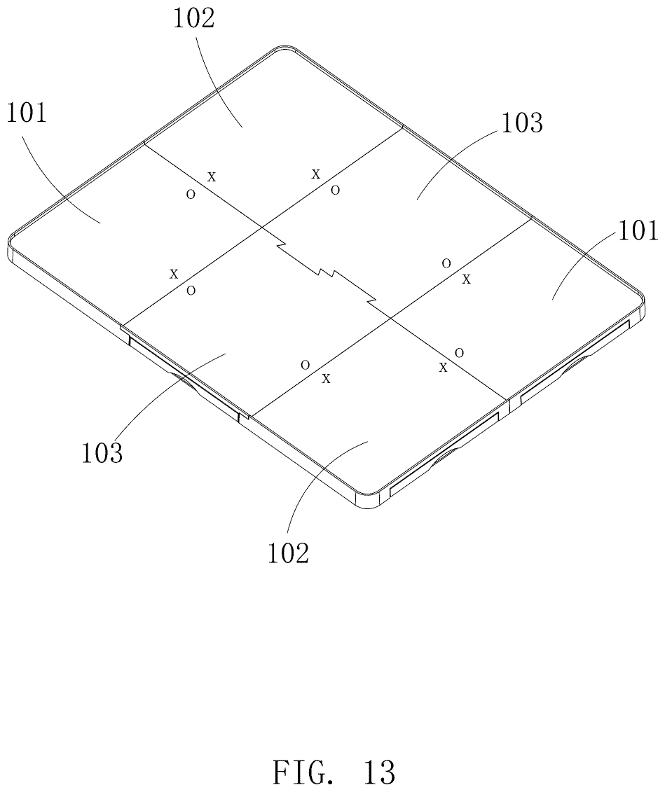

For the purpose of saving molds, in this embodiment, the aforementioned at least two puzzle plates 1 include two first plates 101, two second plates 102, and two third plates 103. As shown in FIG. 13, “O” represents a position where the first connecting element 21 is disposed, and “X” represents a position where the second connecting element 22 is disposed. Each first plate 101 is connected with one first connecting element 21 and one second connecting element 22. Each second plate 102 is connected with two second connecting elements 22. Each third plate 103 is connected with two first connecting elements 21. Each third plate 103 is connected with one first plate 101 and one second plate 102. Two third plates 103 are connected with each other side by side. In this way, each first plate 101 is adjacent to one second plate 102 and one third plate 103. Two first plates 101, two second plates 102, and two third plates 103 are spliced to form a rectangular puzzle table. In detail, the two first plates 101 are centrosymmetric with each other, the two second plates 102 are centrosymmetric with each other, and the two third plates 103 are centrosymmetric with each other. In this embodiment, the puzzle table includes six puzzle plates 1 in total, but only three sets of molds are required to be designed.

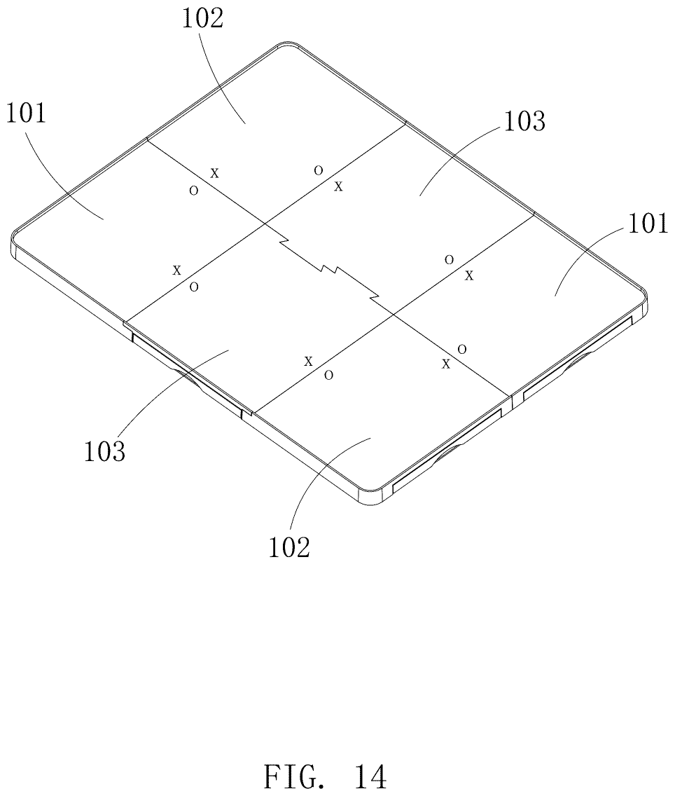

For the purpose of saving molds, in another embodiment, the aforementioned at least two puzzle plates 1 include four first plates 101 and two third plates 103, and the at least one connecting assembly 2 includes six connecting assemblies 2. As shown in FIG. 14, “O” represents a position where the first connecting element 21 is arranged, and “X” represents a position where the second connecting element 22 is arranged. Each first plate 101 is connected with one first connecting element 21 and one second connecting element 22. Each third plate 103 is connected with one first connecting element 21 and one second connecting element 22. Each third plate 103 is connected with two first plates 101. Two third plates 103 are connected with each other side by side. In this way, each first plate 101 is adjacent to another first plate 101 and one third plate 103, and the four first plates 101 and two third plates 103 are spliced to form a rectangular puzzle table. Particularly, the four first plates 101 are completely the same and arranged in a circular array. The two third plates 103 are centrosymmetric with each other. In this embodiment, the puzzle table includes six puzzle plates 1 in total, but only two sets of molds need to be designed.

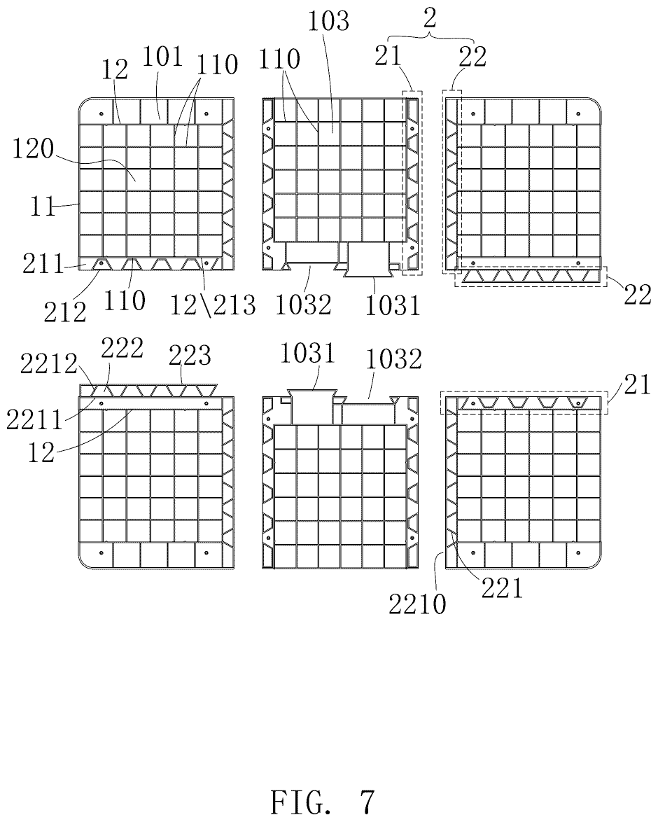

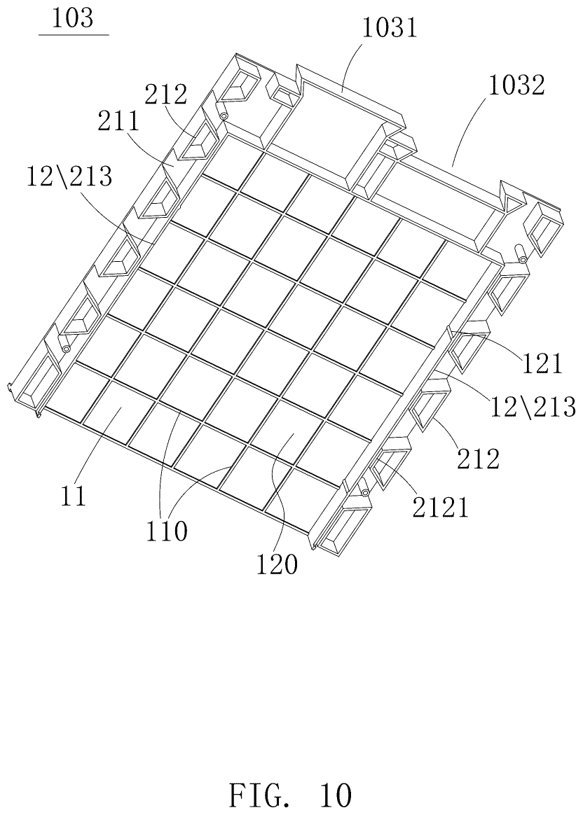

In addition, the two third plates 103 may be connected with each other by one connecting assembly 2. Alternatively, the two third plates 103 may be completely fixed to each other without any one connecting assembly 2. However, limited by materials and manufacturing processes, there may be a large gap between the two third plates 103. In this embodiment, in order to reduce the gap between the two third plates 103, each third plate 103 is arranged with an anti-disengagement boss 1031 and defines an anti-disengagement groove 1032. The anti-disengagement boss 1031 of each third plate 103 can be received in the anti-disengagement groove 1032 in the other third plate 103. A shape of the anti-disengagement boss 1031 is shown in FIGS. 7 and 10. The anti-disengagement boss 1031 designed as an inverted trapezoid can, in a first aspect, strengthen connection strength between the two third plates 103 and prevent the two third plates 103 from being misaligned with each other, and in a second aspect, prevent the two third plates 103 from separating from each other, i.e., prevent the gap between the two third plates 103 from becoming larger.

Further, in order to enhance splicing reliability of the puzzle table, in an embodiment, the puzzle table further includes a base 3, and the base 3 is connected to a bottom portion of each of the at least two puzzle plates 1.

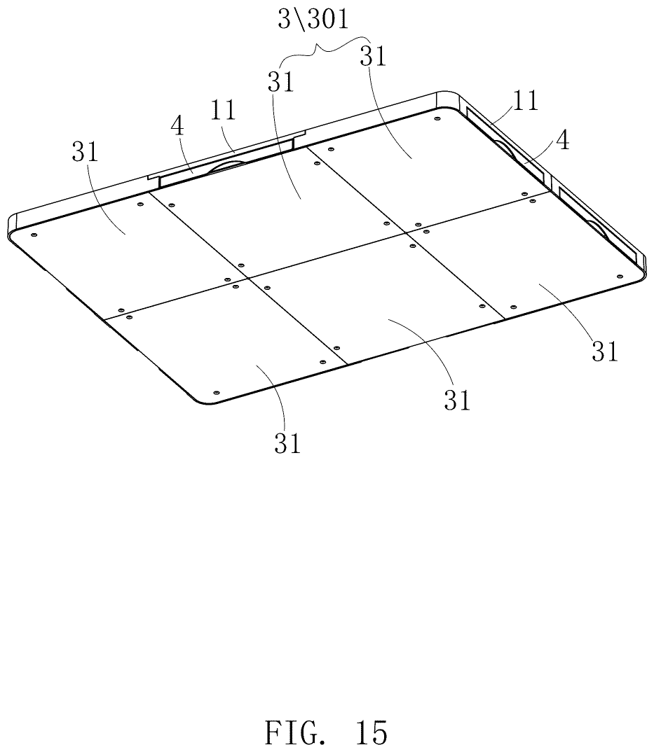

In an embodiment, the base 3 is arranged as a plate-like structure 301. Particularly, the base includes a bottom plate 31. The bottom plate 31 is fixedly connected to a corresponding puzzle plate 1 or a corresponding first connecting portion 211. As shown in FIG. 15, the plate-like structure 301 includes a plurality of bottom plates 31. A number of the plurality of bottom plates 31 is the same as a number of the at least two puzzle plates 1. The plurality of bottom plates 31 are located below the at least two puzzle plates 1, i.e., the plurality of bottom plates 31 are located at a side of the at least two puzzle plates away from the upper faces 10. During an assembly of the puzzle table, after the inserting bosses 212 are inserted into the inserting grooves 222 from the top to the bottom of the inserting grooves 222, the bottom plates 31 can be fixedly connected to the first connecting portions 211 or the puzzle plates 1 by screws 5. Therefore, after the bottom plates 31 are fixed to the first connecting portions 211 or the puzzle plates 1, each first connecting element 21 can be prevented from being detached from a corresponding second connecting element 22, further strengthening the connection strength between each first connecting element 21 and a corresponding second connecting element 22.

In another embodiment, the base 3 is arranged as an annular structure 302 and a bearing-type rotation structure. At least a part of each puzzle plate 1 is connected to the base 3, in this way, a fixation between the base 3 and each puzzle plate 1 is strengthened through the annular structure 302. The annular structure 302 is used to enable a whole of the puzzle table to be rotatable.

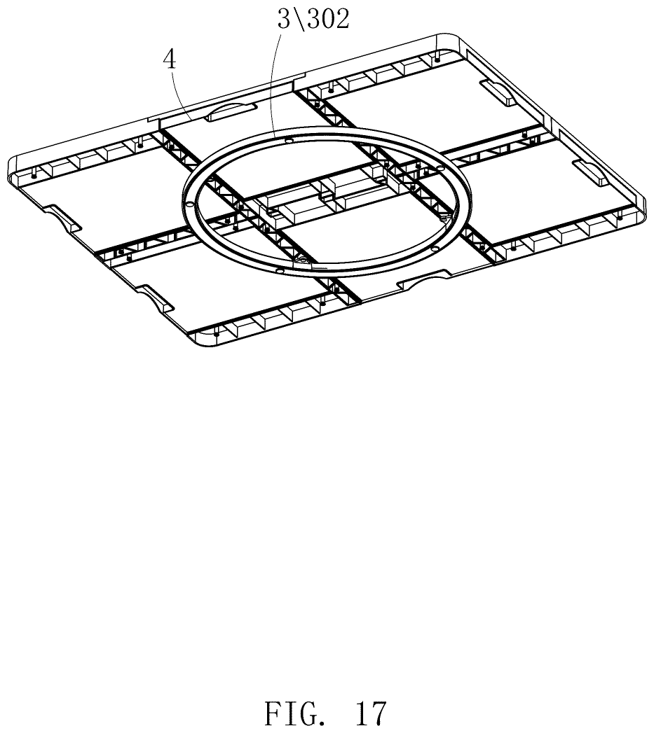

In other embodiments, two bases 3 may be arranged. During the assembly of the puzzle table, as shown in FIG. 17, first, the plate-like structure 301 is connected to all of the at least two puzzle plates 1, and then the annular structure 302 is mounted on a side of the plate-like structure 301 away from the puzzle plates 1 for use as a rotating component.

In an embodiment, the puzzle table further includes a drawer element 4. Specifically, each puzzle plate 1 includes a top plate 11 and at least two side plates 12. All of the at least two side plates 12 are parallel to each other, and each side plate 12 is perpendicular to the top plate 11. The top plate 11 and at least two side plates 12 enclose to form a drawing groove 120. The drawer element 4 is slidably arranged in the drawing groove 120, and the drawer element 4 is capable of sliding in an extension direction of the at least two side plates 12. In addition, the at least two side plates 12 may be arranged with an anti-disengagement structure to prevent the drawer element 4 from being detached downward from the drawing groove 120. In an embodiment, the aforementioned bottom plate 31 can be used as the anti-disengagement structure.

It should be noted that the puzzle plate 1 may be independently arranged with the side plates 12, alternatively the baffle 213 can be used as a side plate 12. For example, as shown in FIG. 8, the first plate 101 is arranged with one side plate 12 and one baffle 213, and the baffle 213 is also used as the side plate 12. As shown in FIG. 10, the third plate 103 is arranged with two baffles 213, and the two baffles 213 are concurrently used as two side plates 12.

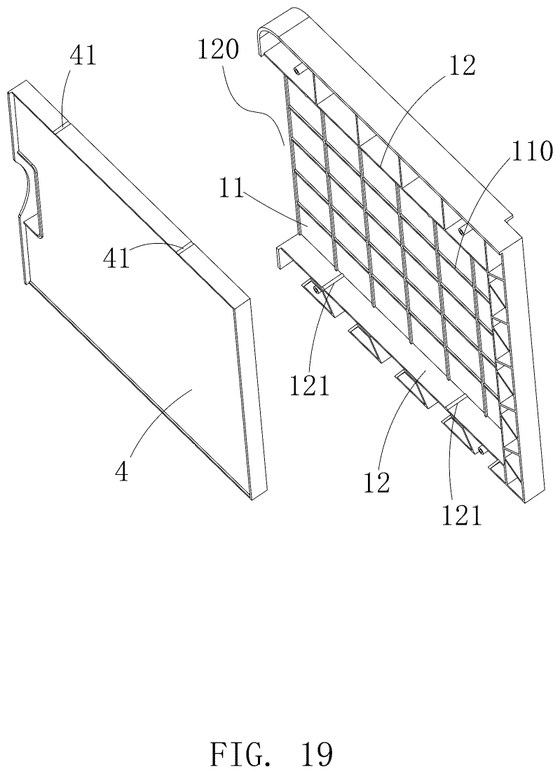

Further, referring to FIG. 19, the at least two side plates 12 are arranged with at least one clamping boss 121, and the drawer element 4 defines at least one clamping groove 41. The drawer element 4 can slide along the side plates 12, so that the clamping boss 121 can be clamped into the clamping groove 41. The clamping boss 121 can provide a fixed position for the drawer element 4. When the clamping boss 121 is clamped into one clamping groove 41, the position of the drawer element 4 can be fixed. Only until the user applies an external force on the drawer element 4 and the clamping boss 121 deforms and then disengages from the groove 41, can the drawer element 4 continue to change its position.

Particularly, the drawer element 4 defines at least two clamping grooves 41 distributed along a sliding direction of the drawer element 4, and the side plates 12 are correspondingly arranged with at least two clamping bosses 121. Each clamping boss 121 matches and may be clamped into any one clamping groove 41.

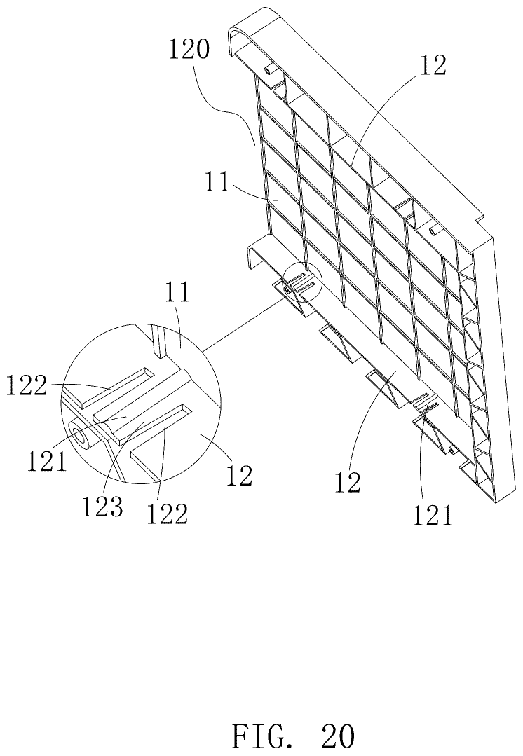

Further, as shown in FIG. 20, elastic notches 122 are respectively defined in two sides of the clamping boss 121. The elastic notches 122 extend towards the top plate 11, such that an elastic post 123 is formed between the two elastic notches 122. The elastic post 123 is elongated allows the elastic post 123 to support an increased amount of elastic deformation. The clamping boss 121 is formed on the elastic post 123, such that clamping between the drawer element 4 and the clamping boss 121 is more durable.

Since the top plate 11 is relatively thin, and in order to improve strength of the top plate 11 and prevent the top plate 11 from collapsing into the drawing groove 120, in the present embodiment, a plurality of supporting bars 110 are arranged on a bottom face of the top plate 11. The plurality of supporting bars 110 cross to form a grid-like structure, thus enhancing structural strength of the top plate 11.

For example, in the first plate 101 shown in FIG. 8, two adjacent edges of the top plate 11 extend downward to form the baffle 213 and the edge plate 2211. The first connecting portion 211 is arranged at a side of the baffle 213 away from the top plate 11, and the second connecting portion 221 is arranged at a side of the edge plate 2211 away from the top plate 11. The baffle 213, the edge plate 2211, and the side plate 12 jointly enclose to form the drawing groove 120. The top plate 11, the side plate 12, the baffle 213, the inserting bosses 212, the first connecting portion 211, the edge plate 2211, the wall plates 2212, the clamping plate 223, and the supporting bars 110 are integrally formed as a one-piece structure. In other words, the molding of the first plate 101 and the first and second connecting elements 21, 22 connected to the first plate 101 can be achieved by one-time mold opening.

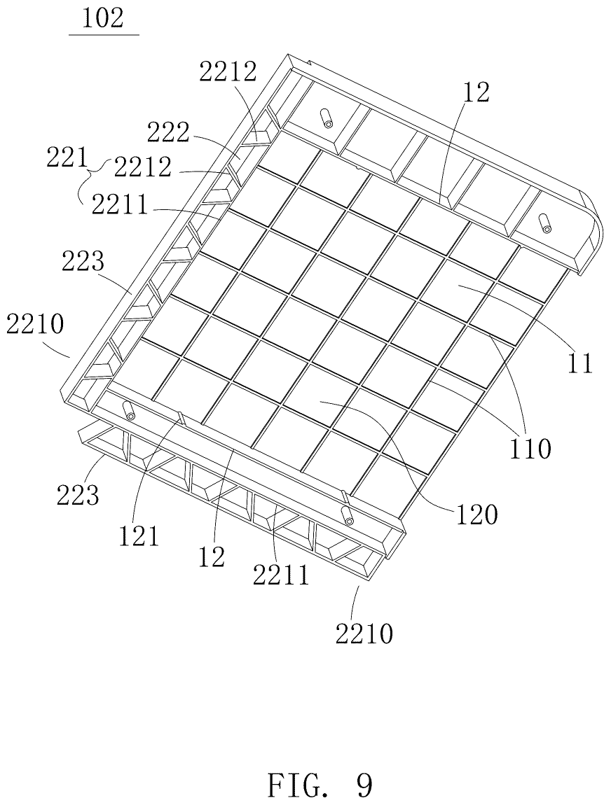

For example, regarding the second plate 102 shown in FIG. 9, two adjacent edges of the top plate 11 extend downward to form two edge plates 2211. One of the two second connecting portions 221 is arranged on a side of a corresponding edge plate 2211 away from the second plate 102, and the other of the two second connecting portions 221 is arranged on a side of the other edge plate 2211 away from the second plate 102. One side plate 12 and the two edge plates 2211 jointly enclose to form the drawing groove 120. The top plate 11, the side plate 12, the edge plates 2211, the wall plates 2212, the clamping plate 223, and the supporting bars 110 are integrally formed as a one-piece structure. In other words, the molding of the second plate 102 and the two second connecting elements 22 connected to the second plate 102 can be completed by one-time mold opening.

For example, for the third plate 103 shown in FIG. 10, two opposite side edges of the top plate 11 extend downward to form two baffles 213. One of the two first connecting portions 211 is arranged at a side of a corresponding baffle 213 away from the third plate 103, and the other of the two first connecting portions 211 is arranged at a side of a corresponding other of the two baffles 213 away from the third plate 103. The drawing groove 120 is formed between the two baffles 213. The top plate 11, the side plates 12/the baffles 213, the inserting bosses 212, the first connecting portions 211, and the supporting bars 110 are integrally formed as a one-piece structure. In other words, the molding of the third plate 103 and the two first connecting elements 21 connected to the third plate 103 can be completed by one-time mold opening.

It should be noted that, in order to facilitate identification of the inserting boss 212, the inserting bosses 212 are represented in a dark color in FIGS. 2, 4 and 5.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. A puzzle table, comprises:
at least two puzzle plates;
at least one connecting assembly, wherein each of the at least one connecting assembly is configured to connect two adjacent puzzle plates of the at least two puzzle plates;
wherein the each of the at least one connecting assembly comprises a first connecting element and a second connecting element, the first connecting element is mounted on one of the at least two puzzle plates, the second connecting element is mounted on an adjacent other of the at least two puzzle plates, and the first connecting element and the second connecting element are capable of being inserted into each other;
when the first connecting element and the second connecting element are inserted into each other, the at least two puzzle plates are spliced with each other, and upper faces of the at least two the puzzle plates are substantially flush with each other.

2. The puzzle table as claimed in claim 1, wherein the first connecting element and the second connecting element are inserted into each other in an interference fit.

3. The puzzle table as claimed in claim 1, wherein an inserting direction between the first connecting element and the second connecting element is perpendicular to the upper faces of the at least two puzzle plates.

4. The puzzle table as claimed in claim 1, wherein the first connecting element comprises a first connecting portion, an inserting boss is arranged on the first connecting portion, the second connecting element comprises a second connecting portion, and the second connecting portion defines an inserting groove;
each of the first connecting portion and the second connecting portion is connected with a corresponding puzzle plate of the at least two puzzle plates, and the inserting boss is capable of being inserted into the inserting groove.

5. The puzzle table as claimed in claim 4, wherein the first connecting element further comprises a baffle arranged on the first connecting portion, and a clamping gap is defined between the inserting boss and the baffle;
the second connecting element further comprises a clamping plate, and the clamping plate is connected to the second connecting portion;
when the inserting boss is inserted into the inserting groove, the clamping plate is disposed in the clamping gap.

6. The puzzle table as claimed in claim 5, wherein the inserting boss and the baffle jointly squeeze the clamping plate.

7. The puzzle table as claimed in claim 6, wherein the second connecting portion comprises an edge plate and at least two wall plates, the edge plate is connected to the corresponding puzzle plate, the clamping plate is connected to the edge plate through the at least two wall plates, and the edge plate, the clamping plate, and the at least two wall plates jointly enclose to form the inserting groove.

8. The puzzle table as claimed in claim 7, wherein the inserting boss has a first abutting face, the first abutting face is a flat or curved face, and the clamping plate has a second abutting face corresponding to the inserting groove; a shape of the second abutting face matches a shape of the first abutting face, and the first abutting face abuts against the second abutting face.

9. The puzzle table as claimed in claim 4, wherein the first connecting portion is in a plate-like shape, and the inserting boss is arranged on a bottom face of the first connecting portion.

10. The puzzle table as claimed in claim 9, wherein the first connecting portion overlaps on the second connecting portion, and an upper face of the first connecting portion is flush with an upper face of the corresponding puzzle plate; the inserting groove vertically penetrates the second connecting portion, and the inserting boss is capable of being vertically inserted into the inserting groove from a top to a bottom of the inserting groove.

11. The puzzle table as claimed in claim 1, wherein each of the first connecting element and the second connecting element is integrally formed on and connected with a corresponding puzzle plate of the at least two puzzle plates as a one-piece structure.

12. The puzzle table as claimed in claim 1, wherein the at least two puzzle plates comprise two first plates, two second plates, and two third plates, and the at least one connecting assembly comprises six connecting assemblies;
wherein each of the two first plates is connected with one first connecting element and one second connecting element, each of the two second plates is connected with two second connecting elements, and each of the two third plates is connected with two first connecting elements; the each of the two third plates is connected with one first plate of the two first plates and one second plate of the two second plates, the two third plates are connected with each other side by side, the each of the two first plates is adjacent to one of the two second plates and one of the two third plates, and two first plates, two second plates, and two third plates are spliced with each other and jointly form a rectangular puzzle table; or
the at least two puzzle plates comprise four first plates and two third plates, and the at least one connecting assembly comprises six connecting assemblies;
wherein each of the four first plates is connected with one first connecting element and one second connecting element, and each of the two third plates is connected with one first connecting element and one second connecting element; each of the two third plates is connected with two first plates, the two third plates are connected with each other side by side, each of the four first plates is adjacent to another of the four first plates and one of the two third plates, and the four first plates and the two third plates are spliced with each other and jointly form a rectangular puzzle table.

13. The puzzle table as claimed in claim 12, wherein the two first plates are centrosymmetric with each other, the two second plates are centrosymmetric with each other, and the two third plates are centrosymmetric with each other.

14. The puzzle table as claimed in claim 12, wherein the each of the two third plates is arranged with an anti-disengagement boss and defines an anti-disengagement groove, and the anti-disengagement boss of the each of the two third plates is connected with the other of the two third plates and located in the anti-disengagement groove of the other of the two third plates.

15. The puzzle table as claimed in claim 4, further comprising a base, wherein the base is connected to a bottom portion of the at least two puzzle plates.

16. The puzzle table as claimed in claim 15, wherein the base is connected with each of the at least two the puzzle plates.

17. The puzzle table as claimed in claim 16, wherein the base is in a plate-like shape and comprises a bottom plate, and the bottom plate is fixedly connected to the each of the at least two puzzle plates or the first connecting portion.

18. The puzzle table as claimed in claim 17, wherein the base comprises a plurality of bottom plates, a number of the plurality of bottom plates is the same as a number of the at least two puzzle plates, and the plurality of bottom plates are located at the bottom portion of the at least two puzzle plates; the inserting boss is capable of being inserted into the inserting groove from a top to a bottom of the inserting groove, and each of the plurality of bottom plates is fixedly connected to a corresponding one of the at least two puzzle plates and/or a corresponding first connecting portion.

19. The puzzle table as claimed in claim 15, wherein the base is in an annular shape.

20. A puzzle table, comprising at least two puzzle plates, wherein each of the at least two puzzle plates comprises a top plate and at least two side plates, and the top plate and the at least two side plates enclose to form a drawing groove;
the puzzle table further comprises a drawer element, and the drawer element is slidably arranged in the drawing groove;
the at least two side plates are arranged with at least one clamping boss, the drawer element defines at least one clamping groove, all of the at least two side plates are arranged in parallel to each other, the drawer element is capable of sliding along the at least two side plates, and the at least one clamping boss is capable of being clamped in the at least one clamping groove.

21. The puzzle table as claimed in claim 20, wherein the drawer element defines at least two clamping grooves along a sliding direction of the drawer element, the at least two side plates are arranged with at least two clamping bosses, and each of the at least two clamping bosses is capable of being clamped in each of the at least two clamping grooves.

22. The puzzle table as claimed in claim 20, wherein a plurality of supporting bars are arranged on a bottom face of the top plate, and the plurality of supporting bars cross to form a grid-like structure.
